(19) United States
(12) Patent Application Publication
(10) Pub. No.: US 2007/0294171 A1
(43) Pub. Date: Dec. 20, 2007

(54) Method and apparatus for providing a virtual universe

(76) Inventor: Eric Sprunk, Carlsbad, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/447,561

(22) Filed: Jun. 6, 2006

(51) Int. Cl. H04L 9/00

(52) U.S. Cl. 705/50

(57) ABSTRACT

A method and apparatus of providing a virtual universe associated with a product is disclosed. A virtual universe of amenities is established. The virtual universe of amenities is sponsored by the vendor of a product. A security code is provided as part of the sale of the product. The security code provides access to a portion of the virtual universe of amenities. A user is permitted to access the portion of the virtual universe of amenities when the security code is authenticated at a virtual universe server.

### BACKGROUND OF THE DISCLOSURE

1. Field of the Disclosure

The present disclosure relates to data security systems. In particular, it relates to data security systems to provide access to a virtual universe.

2. General Background

Many products sold in high volumes are standardized and commoditized. Accordingly, product differentiation is a difficult task. Often these products are differentiated solely based on price. As products such as broadband service or cellular communication service continue to drop dramatically in price, product providers, manufacturers, and vendors attempt to differentiate their products by adding features. There is a limited number of features that may be utilized to differentiate a product without adding unacceptable cost to the product.

Thus, the only available means of differentiation is to provide an inexpensive feature which generally proves to be of modest value to the consumer, and tends to be quickly matched by the competition. Occasionally, an exceptional and inexpensive feature motivates consumer purchase. Fundamentally, the ability to differentiate lower-end products is intrinsically limited.

### SUMMARY

In one aspect, there is a method of providing a virtual universe associated with a product. A virtual universe of amenities is established. The virtual universe of amenities is sponsored by the vendor of a product. A security code is provided as part of the sale of the product. The security code provides access to a portion of the virtual universe of amenities. A user is permitted to access the portion of the virtual universe of amenities when the security code is authenticated at a virtual universe server.

In another aspect, there is a virtual universe server configured to provide a virtual universe in association with a product. The virtual universe server may include a computer processor and an access security module. The computer processor may provide connectivity to a virtual universe of amenities to authenticated users. The virtual universe of amenities may be sponsored by the vendor of a product. The access security module may be configured to authenticate a security code for accessing a portion of the virtual universe of amenities. The security code is provided to a purchaser of the product as part of a sale of the product.

In yet another aspect, there is a client computer configured to access a virtual universe of amenities. The client computer may include a computer processor and an amenities processing module. The computer processor may be configured to receive an access code from a client computer user. The access code may provide authentication to gain access to the virtual universe of amenities. The computer user may obtain the access code in association with the purchase of a product. The virtual universe of amenities may be sponsored by the vendor of the product. Furthermore, the amenities processing module may provide the client computer user with amenities of a portion of the virtual universe of amenities. The client computer user may be provided with the amenities when the security code is authenticated at a virtual universe server.

### BRIEF DESCRIPTION OF THE DRAWINGS

By way of example, reference will now be made to the accompanying drawings.

FIG. 1 illustrates a user's computer in communication with a virtual universe server through a computer network.

FIG. 2 illustrates a block diagram of the virtual universe server.

FIG. 3A illustrates a product that includes an access code.

FIG. 3B illustrates a product that includes the user's computer which stores the access code.

FIG. 4 illustrates a block diagram of the user's computer.

FIG. 5 illustrates a process for providing a virtual universe to consumers of a product.

### DETAILED DESCRIPTION

A method and apparatus of enhancing the value of a commodity product utilizing data security systems is disclosed. Though some vendors may be able to effectively compete based on price alone, a virtual universe with amenities may be provided to the buyer of a product to enhance the marketability of the product. The virtual universe may be accessed through a security system. The security system may employ state-of-the-art security technology to preserve access to the virtual universe solely for the vendor's products. The virtual security system may be cost-effectively added to the commodity product with only a marginal increase in the product's cost. The amenities provided in the virtual universe may include entertainment services, information services, and communications services, among others. In addition, the virtual universe may be provided by one or more servers accessible to the buyer. Other material located in the virtual universe may include advertisements, product trials, sneak previews for content media, or other digital content, etc. The virtual universe may also be a virtual place where the buyers of one or more vendor's products may meet and enjoy virtual attractions and benefits.

In one embodiment, a vendor may provide access to the virtual universe to all buyers of the vendor's products, such that the virtual universe becomes an exclusive network of amenities provided to buyers of the vendor's products. A security function such as access codes may be provided to the buyer as part of the purchase of the product. As such, buyers of products that are not the vendor's products may be excluded from accessing the virtual universe.

Thus, buyers of the products of a vendor have an incentive to buy the products from the vendor over any other product offered by a competitor of the vendor. The incentive to the buyer is the accessibility to an additional feature that the buyer would otherwise have to pay for if bought or acquired independently. As such, the result is that the consumer has another reason, besides price, to buy the vendor's products over those of the competition, namely, access to the virtual universe.

From a total cost perspective, the vendor of the commodity product is able to construct the virtual universe of amenities to benefit all of the vendor's products rather than only selected products. This leverages the investment in the virtual universe over many inexpensive products, distributing the cost in an effective manner. In addition, as more products with virtual universe access are sold and mass-produced, the per-unit cost of each product may decrease. Moreover, as per-unit cost decreases, more products with access to the virtual universe may be offered.

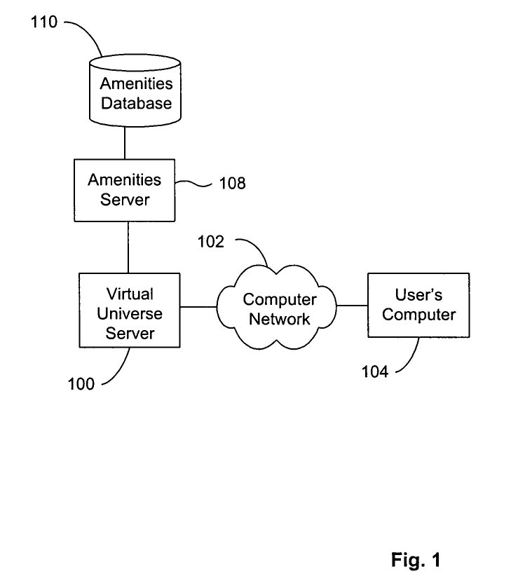

FIG. 1 illustrates a user computer 104 in communication with a virtual universe server 100 through a computer network 102. In one embodiment, the virtual universe server 100 provides users with amenities that are only offered to users who have purchased a specific product. In one example, the virtual universe server 100 is managed and sponsored by the vendor of the product. The vendor of the product provides an incentive to buy the product by providing free or low cost access to the virtual universe. In another example, the virtual universe may be sponsored and/or managed by a consortium of vendors. In yet another example, the virtual universe may be sponsored and/or managed by a third party that is not the vendor.

The computer network 102 is a Local Area Network (“LAN”), a Wide Area Network (“WAN”), the Internet, cable, satellite, etc. In one embodiment, the user computer 104 gains access to the computer network 102 using encryption. For example, the user computer 104 may be provided with a certificate or password that permits the user computer 104 to access the virtual universe server 100. The user computer 104 provides access to the virtual universe of amenities. In one embodiment, the buyer of the product or products offered by the vendor is the user accessing the user computer 104.

In one example, the amenities provided are stored in an amenities database 110, which may be accessed by an amenities server 108. The amenities server 108 retrieves the necessary information from the amenities database 110 to provide information to the virtual universe server 100. The amenities database 110 may store games, video, audio content, or any other amenity provided to the user in the virtual universe of amenities.

Some of the amenities that comprise the virtual universe may be available as an enticement to potential purchasers who have not yet bought any of the vendor's products. Such enticement-based access may be limited in scope or time, so as to hold back some large portion of amenities to motivate the purchase of the vendor's products.

In one embodiment, only users who buy products from the vendor may have access to the virtual universe or a portion of the virtual universe. In another embodiment, the user may buy temporary access to the virtual universe or a portion of the virtual universe. In another embodiment, the user may buy permanent access to the virtual universe or a portion of the virtual universe.

In one embodiment, the amenities are commodities that are inexpensive to the vendor, but add value to the product being offered in combination with the commodity. In another example, the amenities are unrelated to the product that the buyer purchases. For example, the buyer may purchase broadband cable service, and the amenity provided in the virtual universe may be access to an online clothing store.

In another embodiment, access to the virtual universe, or access to a portion of the virtual universe, may occur through the commodity product sold by the vendor. The commodity product may contain virtual universe access capability and security technology.

In another implementation, the vendor provides the virtual universe to buyers of all of the products that the vendor sells. For example, if the vendor is in the business of providing furniture and office supplies, a buyer that purchases a furniture article from the vendor may be provided access to the virtual universe. Likewise, a buyer that purchases an office supply item from the same vendor may be provided access to the same virtual universe. In one embodiment, the amenities offered to each buyer may vary according to the purchased product or service. In another embodiment, the amenities offered to each buyer are independent from the purchased product or service.

Access to the virtual universe may also be provided to users that lease the product. For example, if the user leases the product for a period of two months, the user may have access to the virtual universe during the lease period. In another example, the user may have access to the virtual universe depending on the product being leased.

In addition, access to the virtual universe may also be provided as part of the purchase of the product, but not to the purchaser or lessee of the product, but rather to a third party. Thus, for example, a parent may purchase a product from the vendor, and designate a child to be the beneficiary and have access to the virtual universe. The child may receive an email message containing access information for the product. Alternatively, the parent relays access information to the child, and the child accesses the virtual universe of amenities.

The amenities provided in the virtual universe of amenities may include entertainment services and data, information services and data, communications services and data, retail services, etc. In one embodiment, the amenities provided to the user may be entertainment services. In one example, the amenities database includes music, and the amenities server retrieves music computer files. In another example, the amenities database includes video, and the amenities server retrieves video computer files. In yet another embodiment, the virtual universe server 100 streams virtual content to the user computer 104. Virtual content may include media content such as video (clips, news footage, shorts, a feature movie, etc.), or audio (new song releases, news, historical information, etc).

In another embodiment, the amenities provided to the user comprise information. In one example, the amenities provided to the user comprise an encyclopedia. In another example, the amenities provided to the user comprise a multimedia presentation. In another example, the amenities provided to the user comprise educational material.

In another embodiment, the amenities provided to the user include retail services. In one example, retail services include discounted shopping from an Internet clothing store. In one example, retail services include discounted shopping from an Internet bookstore. In yet another example, the amenities provided to the user include special sales promotions or coupons.

In yet another embodiment, the amenities provided to the user include online games, online multiplayer games, and virtual reality experiences. The virtual universe may also include a real experience universe, such as entertainment environments, coliseums, theaters, etc. In another embodiment, the amenities may comprise avatar characteristics or skills for use in an online game or virtual reality, or any resource employed in such environments such as virtual money, virtual food, virtual air, virtual fuel, or other virtual supplies. In another embodiment, the amenities provided to the user include Internet services such as email, chat rooms, storage space, remote access, etc.

In another embodiment, the amenities provided to the user include traveling services. In one example, traveling services may include being able to book flight tickets, rail tickets, or car rental other transportation tickets. In another embodiment, traveling services may include booking accommodation services.

In one embodiment, only users having access privileges are provided with the amenities in the virtual universe. Access privileges may be provided only to those who buy the product, such that the services provided by the virtual universe are a form of reward. In addition, amenities may be made highly attractive, further adding to the appeal of having exclusive access to the virtual universe.

In one embodiment, the user computer 104 is configured to gain access to the virtual universe server 100 based on security codes or passwords previously provided to the user. In another embodiment, the user is a returning user, and cookies may be installed in the user computer 104 so that a returning user at the user computer 104 may be validated.

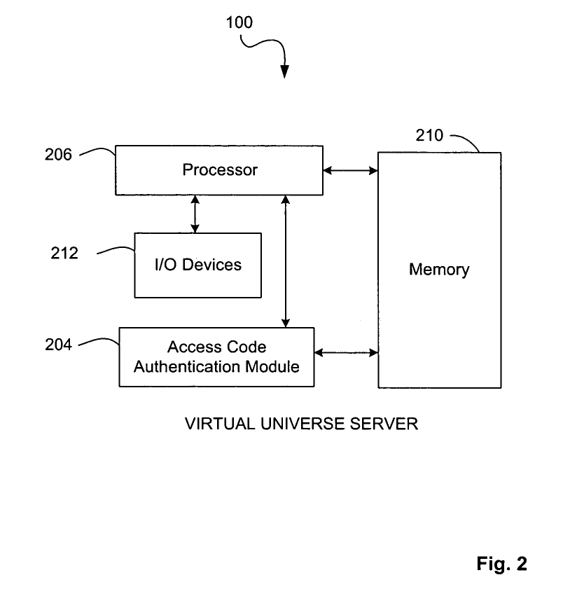

FIG. 2 illustrates a block diagram of the virtual universe server 100. The server may be employed to authenticate and provide virtual universe services to the user. Thus, the virtual universe server 100 comprises a processor 206, a memory 210, e.g., a random access memory (RAM) and/or read only memory (ROM), a security access security module 204, and various input/output devices 212, (e.g., storage devices, including but not limited to, a tape drive, a floppy drive, a hard disk drive or a compact disk drive, a receiver, a transmitter, a speaker, a display, an image capturing sensor, e.g., those used in a virtual still camera or virtual video camera, a clock, an output port, a user input device (such as a keyboard, a keypad, a mouse, and the like, or a microphone for capturing speech commands)). In addition, input/output devices 212 may include an outbound network interface, an inbound network interface, Ethernet port, TCP/IP ports, wireless ports, or any other communication ports necessary for network connectivity.

The access security module 204 may be implemented as one or more physical devices that are coupled to the processor 206 through a communication channel, including for chips within the device or attached dongles. Alternatively, the access security module 204 may be represented by one or more software applications (or even a combination of software and hardware, e.g., using application specific integrated circuits (ASIC)), where the software is loaded from a storage medium, (e.g., a magnetic or optical drive or diskette) and operated by the processor 206 in the memory 210 of the virtual universe server 100. As such, the access security module 204 (including associated data structures) of the present invention may be stored on a computer readable medium, e.g., RAM memory, magnetic or optical drive or diskette and the like.

In addition, the access security module 204 includes logic to determine whether the access code provided by the user is a valid access code. In another embodiment, the access security module 204 further determines the type of access that the user will be granted upon authentication. For example, access may limited to a period of time. In another example, access may be granted to a limited number of amenities. In yet another example, access may be granted for a certain type of amenities. In another embodiment, the memory 210 may store logic to provide amenities to the user based on the access code.

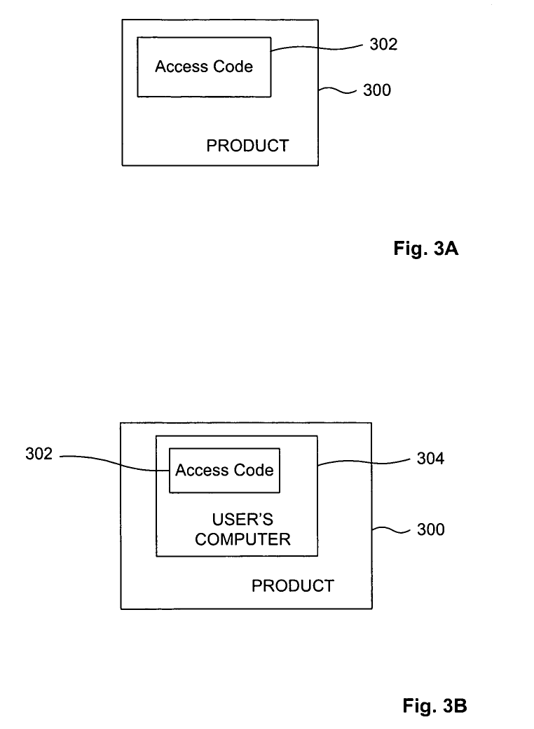

FIG. 3A illustrates a product 300 that includes an access code 302. A vendor that sponsors the product 300 sells products that are more enticing by selling the product 300 with access to a virtual universe of amenities. The virtual universe of amenities may provide the user with virtual experiences or other valuable amenities as described herein. Therefore, only buyers that purchase the product 300 may be offered access to the virtual universe of amenities. Once a buyer purchases the product 300, the user may be provided with an access code 302.

In one embodiment, an access code 302 is provided to the user by including a certificate printed with the access code 302. The certificate may be provided at the time of purchase or later mailed. In another embodiment, the access code 302 is provided electronically to the user. In one example, the user provides the user's email address and the access code 302 is sent in electronic mail to the user. In another example, the user may receive the access code 302 at a wireless device of the user.

Products sold may include any goods or services. For example, goods may include electronic devices and accessories, apparel and accessory items, automotive artifacts, food and cooking items, etc. In one embodiment, the user buys the goods on the Internet on a dedicated commercial website provided by the vendor. In another embodiment, the user buys the goods at the store of a vendor. In another embodiment, the user buys the goods by calling an ordering telephone line provided by the vendor of the product 300.

In another example, services may include telecommunication services, traveling arrangement services, real estate services, entertainment services, etc. In one embodiment, the user orders the service on the Internet on a dedicated commercial website provided by the vendor. In another embodiment, the user orders the service at store of a vendor. In another embodiment, the user orders the service by calling an ordering telephone line provided by the vendor of the product 300. For example, the product 300 may be broadband cable service delivered to a home. The user calls the vendor or a vendor's agent and requests broadband service. As part of the delivery of the service, the user is provided with an access code 302 to the virtual universe of the vendor. Once the user accesses the virtual universe, the virtual universe of the vendor may provide the user with an online store of media content at discounted prices.

In yet another example, the product 300 may be services for virtual core gateways, broadband services, wireless security, multi-function radio, content sharing, content management, multimedia technology, self-organizing pervasive networks, personal safety and security services, imaging products and services, automotive products, virtual technologies, etc.

FIG. 3B illustrates product 300 which includes the user computer 304 having an access code 302. In one embodiment, the product 300 may include an electronic access code 302 or a virtual certificate stored in a memory of the product 300. For example, the product 300 may be implemented as one or more physical electronic devices. In another example, the product 300 is the user computer 304. Thus, the user may buy an electronic device from a vendor that offers a virtual universe. The electronic device itself may contain the access code 302 to access the virtual universe.

In one example, the electronic device is a cellular telephone that includes an access code 302 to a virtual universe of free digital pictures. In another example, the electronic device is a broadband cable modem that includes access codes 302 to a virtual universe of discounted media delivery.

Once the user buys the product 300, the user may utilize the electronic device to access the virtual universe. The electronic device may be provided with Ethernet ports, WiFi communication capability, or network connectivity capability so as to connect to the virtual universe server 100, request access by providing the access code 302, and interact with the amenities offered in the virtual universe.

In another embodiment, the product 300 including the electronic device may include access codes for further functionality and connectivity to the virtual universe provided by the vendor.

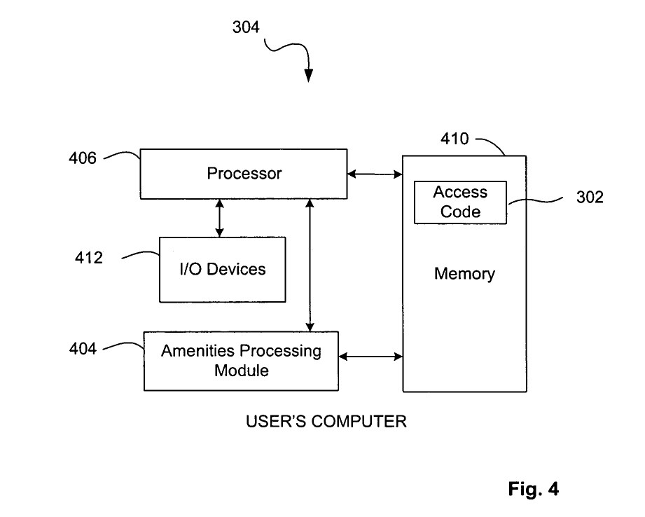

FIG. 4 illustrates a block diagram of the user computer 304. Specifically, the users computer 304 may be coupled with the product 300 sold or leased to a user. Thus, the user computer 304 may connect to the computer network 102 and to the virtual universe server 100 and receive access to amenities offered by the virtual universe. In one embodiment, the user computer 304 is implemented using a general-purpose computer or any other hardware equivalents.

Thus, the user computer 304 comprises a processor 406, a memory 410, e.g., a random access memory (RAM) and/or read only memory (ROM), amenities processing module 404, and various input/output devices 412, (e.g., storage devices, including but not limited to, a tape drive, a floppy drive, a hard disk drive or a compact disk drive, a receiver, a transmitter, a speaker, a display, an image capturing sensor, e.g., those used in a virtual still camera or virtual video camera, a clock, an output port, a user input device (such as a keyboard, a keypad, a mouse, and the like, or a microphone for capturing speech commands)).

It should be understood that the amenities processing module 404 may be implemented as one or more physical devices that are coupled to the processor 206 through a communication channel. Alternatively, the amenities processing module 404 may be represented by one or more software applications (or even a combination of software and hardware, e.g., using application specific integrated circuits (ASIC)), where the software is loaded from a storage medium, (e.g., a magnetic or optical drive or diskette) and operated by the processor 406 in the memory 410 of the user computer 304. As such, the amenities processing module 404 (including associated data structures) of the present invention may be stored on a computer readable medium, e.g., RAM memory, magnetic or optical drive or diskette and the like.

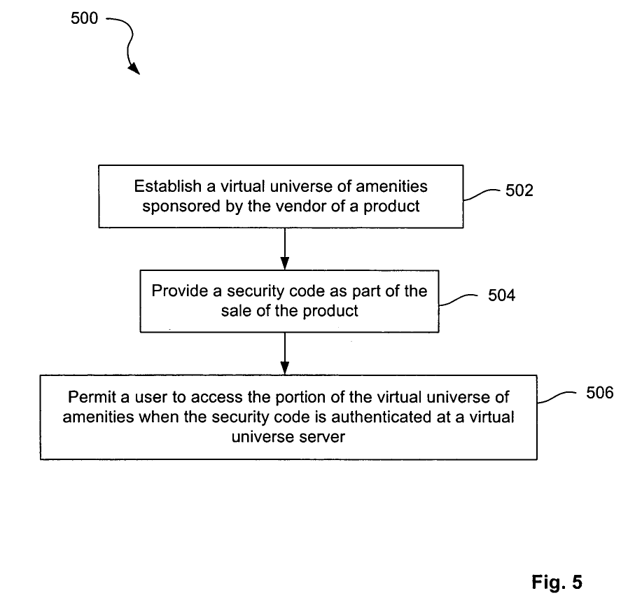

FIG. 5 illustrates a process for providing a virtual universe to consumers of a product 300. At process block 502, a virtual universe of amenities is established. In one embodiment, the vendor of the product 300 establishes the virtual universe of amenities by configuring a virtual universe server to interact with user virtual requests through a closed network. As such, in one embodiment, the virtual universe may be funded, sponsored, and/or managed by the vendor. The virtual universe, in another embodiment, may be sponsored and/or managed by a consortium of vendors. In yet another embodiment, the virtual universe may be sponsored and/or managed by a third party that is not the vendor. The process 500 then continues to process block 504.

At process block 504, a security a security code is provided as part of the sale of the product 300. The security code provides access to the virtual universe of amenities of a portion of the virtual universe of amenities. As discussed above, the security code may be provided in various formats. For example, the security code may be provided as a printed number on a paper ticket, on a computer screen, or on a display of a portable device. In another example, the security code may be provided as a virtual certificate or password delivered in the memory of an electronic device. In one embodiment, the product is the electronic device. The process 500 then proceeds to process block 506.

At process block 506, a user is permitted to access the virtual universe of amenities when the security code is authenticated at the virtual universe server 100. The virtual universe server 100 includes authenticating functions in the access security module 204.

In addition, process 500 may be implemented in a computer readable medium such as a computer magnetic disk, optical discs, or any other computer storage medium.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

What is claimed is:

1. A method of providing a virtual universe associated with a product, comprising:
establishing a virtual universe of amenities, wherein the virtual universe of amenities is sponsored by the vendor of a product;
providing a security code as part of the sale of the product, wherein the security code provides access to a portion of the virtual universe of amenities; and
permitting a user to access the portion of the virtual universe of amenities when the security code is authenticated at a virtual universe server.

2. The method of claim 1, wherein the security code is provided at the time of sale of the product.

3. The method of claim 1, wherein providing a security code as part of the sale of the product comprises providing the purchaser of the product with the security code.

4. The method of claim 1, wherein the virtual universe of amenities is a closed universe exclusively opened to buyers of the product.

5. The method of claim 1, wherein access to the portion of the virtual universe of amenities is provided as part of the sale of any one of a plurality of products of the vendor.

6. The method of claim 1, wherein access to the portion of the virtual universe of amenities is provided for a limited time.

7. The method of claim 1, wherein access to the portion of the virtual universe of amenities is provided based on the value of the product.

8. The method of claim 1, wherein the portion universe of amenities is operated using a computer network.

9. The method of claim 1, wherein the amenities are media content, entertainment services, information services, or communications services.

10. The method of claim 1, wherein the product is an entertainment service, an information service, or a communications service.

11. A virtual universe server configured to provide a virtual universe in association with a product, comprising:
a computer processor that provides connectivity to a virtual universe of amenities to authenticated users, wherein the virtual universe of amenities is sponsored by the vendor of a product; and
an access security module configured to authenticate a security code for accessing a portion of the virtual universe of amenities, wherein the security code is provided to a purchaser of the product as part of a sale of the product.

12. The virtual universe server claim 11, wherein the product is an electronic device that communicates with the virtual universe server through a computer network, and wherein the electronic device comprises a memory module that stores the security code.

13. The virtual universe server claim 11, wherein the virtual universe of amenities is a closed universe exclusively opened to buyers of the product.

14. The virtual universe server claim 11, wherein amenities in the virtual universe of amenities include media content, entertainment services, information services, and communications services.

15. The virtual universe server claim 11, wherein the product is an entertainment service, an information service, or a communications service.

16. A client computer configured to access a virtual universe of amenities, comprising:
a computer processor configured to receive an access code from a client computer user, wherein the access code provides authentication to gain access to the virtual universe of amenities, wherein the computer user obtains the access code in association with the purchase of a product, wherein the virtual universe of amenities is sponsored by the vendor of the product; and
an amenities processing module, wherein the amenities processing module provides the client computer user with amenities of a portion of the virtual universe of amenities, wherein the client computer user is provided with the amenities when the security code is authenticated at a virtual universe server.

17. The client computer of claim 16, wherein access to the portion of the virtual universe of amenities is provided for a limited time.

18. The client computer of claim 16, wherein the virtual universe of amenities is a closed universe exclusively opened to buyers of the product.

19. The client computer of claim 16, wherein the amenities include media content, entertainment services, information services, and communications services.

20. The client computer of claim 16, wherein the product is an entertainment service, an information service, or a communications service.
